(19) United States
(12) Patent Application Publication
(10) Pub. No.: US 2013/0046605 A1
(43) Pub. Date: Feb. 21, 2013

(54) GROUP BUYING METHOD AND SYSTEM FOR GROCERY AND OTHER MULTI-RETAILER ENVIRONMENTS

(71) Applicants: Matthew Baron, Lexington, MA (US); Charles Grindel, Cambridge, MA (US); Nicholas Hays, Cambridge, MA (US); Joshua Herzig-Marx, Newton, MA (US); Margaret Le, Cambridge, MA (US); Benjamin Sprecher, Waltham, MA (US)

(72) Inventors: Matthew Baron, Lexington, MA (US); Charles Grindel, Cambridge, MA (US); Nicholas Hays, Cambridge, MA (US); Joshua Herzig-Marx, Newton, MA (US); Margaret Le, Cambridge, MA (US); Benjamin Sprecher, Waltham, MA (US)

(73) Assignee: INCENTIVE TARGETING, INC., Cambridge, MA (US)

(21) Appl. No.: 13/399,400

(22) Filed: Feb. 17, 2012

Related U.S. Application Data
(60) Provisional application No. 61/446,118, filed on Feb. 24, 2011.

(51) Int. Cl. G06Q 30/02

(52) U.S. Cl. 705/14.27

(57) ABSTRACT

A computer-implemented method enables consumers to purchase products or services from merchants using consumer loyalty programs. The method is implemented in a computer system communicating with client devices operated by consumers and merchants. The method features: (a) transmitting a deal to client devices operated by consumers, the deal enabling consumers to purchase a given product or service from one of a set of one or more merchants; (b) receiving from a client device operated by a consumer a deal purchase including consumer payment information for the given product or service; (c) associating the deal purchase with an identifier of a loyalty program account of the consumer in one or more loyalty programs of the set of one or more merchants; and (d) notifying at least one of the set of one or more merchants of the deal purchase such that the consumer can be credited for the deal purchase.

### CROSS REFERENCE TO RELATED APPLICATION

This application claims priority from U.S. Provisional Patent Application No. 61/446,118, filed on Feb. 24, 2011, entitled GROUP BUYING METHOD AND SYSTEM FOR GROCERY AND OTHER MULTI-RETAILER ENVIRONMENTS, which is hereby incorporated by reference in its entirety.

### BACKGROUND

Group buying (also called “social buying,” “collective buying,” “consumer-funded deal,” “flash deal,” or more generally “daily deal”) websites have exploded in popularity in recent years. Since its founding in November 2008, the most successful of these sites, Groupon, claimed to have sold over 30 million “Groupons,” as their daily deals are known.

The premise of these group buying sites is generally quite simple: one or more high-value deals are highlighted each day, and consumers have a limited amount of time to jump on board and take advantage of the deal or deals. Consumers find out about the deals through direct messages (over email, text message, Facebook, Twitter, and other media) or from the deal website itself. Often, interested consumers will forward deal information on to other individuals (or post the deal using social media), thereby amplifying the distribution of deal information, while simultaneously lending it credibility by virtue of the implied endorsement. This “viral” spread of deals is actively encouraged by group buying sites, which usually provide easy ways for users to forward, “share,” “like,” “Tweet,” or otherwise disseminate information about the deal to the user's friends, contacts, followers, or to the world at large. Often, there are incentives to the user for sharing, such as referral fees or commissions, discounts on the deal for the user and/or friends if enough friends buy it, or other compensation schemes. As a result, some deals have been able to reach hundreds of thousands or even millions of individuals in a matter of a few hours from their launch, and have sold hundreds of thousands of deals in a single day.

Group buying sites use many different tactics to maximize deal purchases, including:

Fostering a sense of urgency though time limits and deal caps (with the limit or cap either explicitly set forth, or mentioned but with the exact value withheld from consumers), as well as through pricing schemes intended to reward early purchasers.

Fostering a sense of camaraderie between purchasers by requiring a minimum number of consumers to buy before the deal “tips” or becomes active for everyone.

Rewarding new user referrals, either with credits or payments.

Encouraging sharing by lowering the deal price as the number of participants increases, providing social media and sharing tools, and creating deal-specific referral bonus schemes.

Sourcing exciting, interesting, and unusual offers.

Extracting large discounts from advertisers (often 50% or more off of retail list prices).

Localizing deals to specific cities or geographies.

Catering to particular consumer interest areas (such as Woot.com for technology and gadgets, or Gilt.com for luxury products).

Encouraging consumers to redeem an offer by having the consumer pre-pay for the deal.

Group buying sites have been especially noteworthy in their ability to charge a premium price for their service. The typical pricing model for a group buying site involves a merchant offering consumers a 50% discount off of the full retail price, which the consumer pays to the group buying site up front. The group buying site then takes a share of the money it collects—typically 20%-50% of the consumer's payment.

Despite the success of group buying sites in the areas of online-only product deals and local small-business deals, group buying as a business model has generally failed to penetrate the world of low-margin, high-volume retail such as the grocery retail environment. There are many reasons for this, including business model challenges.
Unlike in typical Groupon-style group buying deals, there is often a 3-party relationship to negotiate. For a typical group buying deal, the group buying site can negotiate terms with the same entity that will ultimately be applying the deal to a consumer's purchase (e.g., the restaurant or merchant). In grocery, Brands manufacture many of the products that would be promoted in a grocery store, and may opt to pay for many group buying deals. At the same time, merchants are generally the ones who would need to apply the discounts for a consumer at checkout (or apply the rebates, points, and/or rewards to a consumer's account), so a need arises for tracking and clearing deal redemptions between multiple parties.
Traditionally, it has been difficult for merchants using group buying sites to measure or track the effectiveness and incrementality of their promotions. In grocery, Brands and Merchants are coming to expect measurability.
While Brands can have substantial margins, their budgets are often fixed.
Few products within the grocery store are “aspirational”—a hallmark of typical group buying deals.

In addition there are pricing model challenges. Grocery retail chains typically have razor thin margins (often in the 1-2% range), so the common pricing model seen in deals with local Merchants, service providers, and restaurants (a 50% fee coming out of a 50% discount) is untenable for most grocery retail chains.

There are also many redemption model challenges, including:
Grocery Retail Industry Complexity

Numerous chains, stores, and checkout lanes

No cross-chain coordination or integration
Point-of-Sale (POS) Technology Limitations

Complex/antiquated terminals

Limited/no Internet connectivity

Difficulty of Integration to retail back-office
Checkout Efficiency Standards

Delays in the checkout process are unacceptable

Manager intervention typically required for high-value coupons
Fraud

Rampant coupon fraud

Refusal of many grocers to honor high-value digital or print-at-home coupons
Clearinghouses & Reimbursement Shortcomings

Weeks/months to receive results

High fees

Lack of operational or financial transparency

### BRIEF SUMMARY OF THE DISCLOSURE

In accordance with one or more embodiments, a computer-implemented method is provided enabling consumers to purchase products or services from merchants using consumer loyalty programs of the merchants. The method is implemented in a computer system communicating with client devices operated by consumers and merchants over a communications network. The method features the steps of: (a) using the computer system to transmit a deal to a plurality of client devices operated by consumers, the deal enabling consumers to purchase a given product or service from one of a set of one or more merchants; (b) receiving at the computer system from a client device operated by a consumer a deal purchase including consumer payment information for the given product or service; (c) using the computer system to associate the deal purchase received from the consumer with an identifier of a loyalty program account of the consumer in one or more loyalty programs of the set of one or more merchants; and (d) using the computer system to notify at least one of the set of one or more merchants of the deal purchase such that the consumer can be credited for the deal purchase.

In accordance with one or more further embodiments, a computer-implemented method is provided of loading deals purchased by consumers onto their accounts in consumer loyalty programs of merchants. Each deal comprises an incentivized purchase of a given product or service from a given merchant. The method features the steps of: (a) receiving at the computer system a deal purchase including consumer payment information for the given product or service from a consumer; and (b) using the computer system to associate the deal purchase with an identifier of an account of the consumer in the consumer loyalty program of the given merchant such that the consumer is credited for the purchase of the product or service.

### BRIEF DESCRIPTION OF THE DRAWINGS

FIG. 1 is a simplified block diagram illustrating an exemplary network including a Group Buying System in accordance with one or more embodiments.

FIG. 2 is a simplified diagram illustrating the lifecycle of a deal processed by the Group Buying System in accordance with one or more embodiments.

FIGS. 3-7 are simplified diagrams illustrating various exemplary flows of money between parties utilizing the system in accordance with one or more embodiments.

### DETAILED DESCRIPTION

Various embodiments disclosed herein are generally directed to a Group Buying System (“The System”) that alerts Consumers to limited-availability deals and special offers, allows Consumers to share information about deals with other people, lets Consumers buy the deals up front, and then enables Consumers to collect the purchased products in retail locations. The Group Buying System can allow low-margin, high-volume merchants such as grocery stores or discount merchandisers to take advantage of benefits of group-style online buying—including social media integration, high-value discounts, limited availability, and incentives for deal sharing and referrals.

The Group Buying System provides social buying interaction coupled with a system for automatically applying discounts at the point-of-purchase (through a load-to-card feature of a merchant loyalty program) or for automatically crediting an account after the point-of-purchase transaction (through a reconciliation of the specific deal requirements against item-level transaction records for the consumer).

The term “deal” refers to an incentivized offer made to a consumer to purchase a given product or service. The following are non-limiting examples of deals:

$20 of live lobsters for $10

$9.99 dinner for 4 (Rotisserie chicken, 2 hot sides, salad)

1 dozen Valentines roses for $15

$10 of Cola products for $5

$12 of Kellogg's cereal for $6

2 loaves of bread for $2.99

5 assorted packages of Kellogg's Special K cereal, snacks, and bars for $10.

The term “loyalty program” means any scheme by which a merchant or other party tracks the purchase behavior of customers over time on an individual or household level (examples: grocery loyalty cards, airline rewards programs, affiliate rewards networks) or a scheme through which a merchant or other party directs rewards, discounts, perks, status, rebates, points, miles, or other tangible or intangible benefits to specific consumers or households.

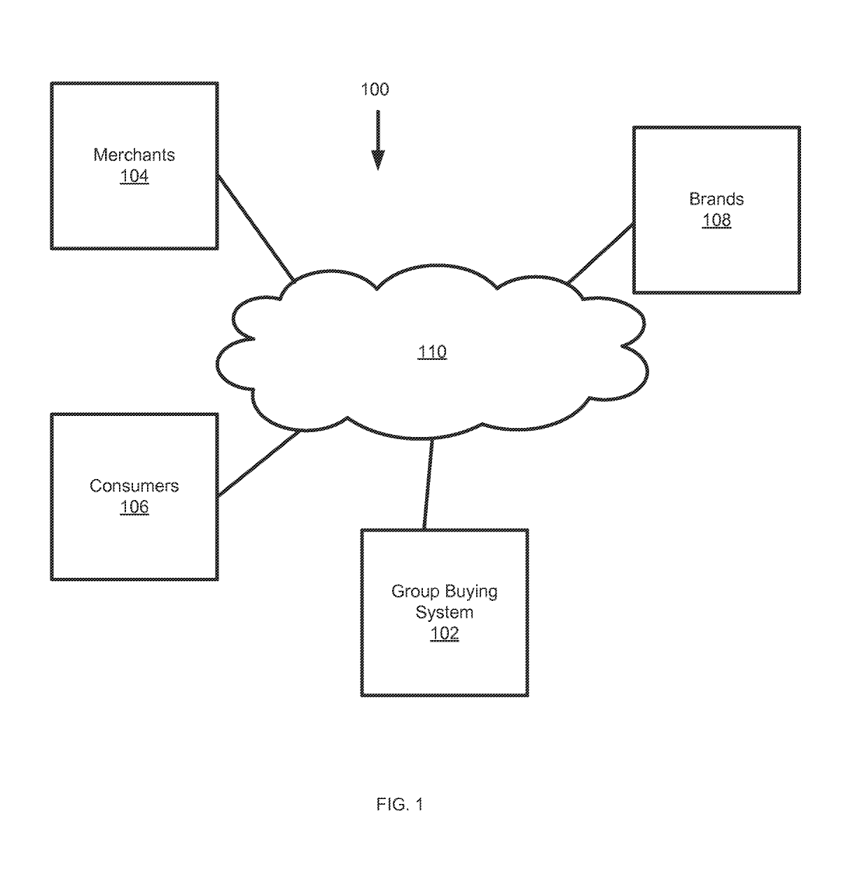

FIG. 1 is a simplified block diagram illustrating an exemplary network 100 including a Group Buying System 102 in accordance with one or more embodiments. The Group Buying System is preferably implemented in a computer server system, which communicates with client devices operated by the various users of the system, including, Merchants 104, Consumers 106, and Brands 108. The client devices can communicate with the Group Buying System over a communications network 110. The network may be any network or combination of networks, including without limitation the Internet, a local area network, a wide area network, a wireless network, and a cellular network. The client devices can comprise any computing device that can communicate with the computer server system including, but not limited to, personal computers, smart phones, cell phones, and tablets.

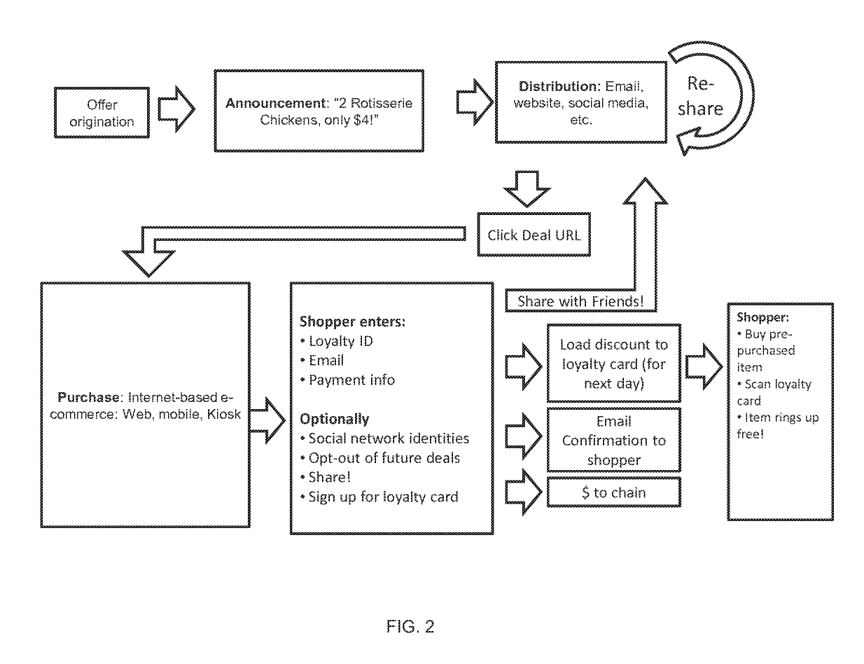

FIG. 2 provides an exemplary overview of the lifecycle of a deal within the Group Buying System in accordance with one or more embodiments.

Initially, a Deal is sourced from one or more Brands and/or one or more Merchants. (As used herein, the term “Brand” refers to a manufacturer, supplier, or other provider of a particular product or service to a Merchant to be sold to a Consumer.) A Deal Page is created in the Group Buying System that contains various information about the Deal including a description of the deal and the specific items being promoted, marketing copy, images, information on time remaining, the number of times the Deal has already been purchased, the number of Deal purchases remaining, any terms and conditions, branding relating to the Merchants and/or Brands involved, and/or any other information relevant to the Deal. The Deal Page may be a web page, as well as differently-formatted versions of the content intended for display in a mobile application, in a text-based application, or in any other context where a Consumer may wish to view and act on a Deal. The Deal page also has a button or other method by which a Consumer can buy the Deal.

Once the Deal Page has been developed, the Merchant(s), Brand(s), and the Group Buying System can share the Deal with various potential buyers. Sharing can be accomplished in any number of ways, including but not limited to:
An email message with links to the Deal Page;
A SMS or MMS or other short-form message with a link to the Deal Page;
Messaging, liking, Tweeting, or otherwise posting on Facebook, Twitter, or any other social media site or to any direct connections on such a site, with a link to the Deal Page;
Notification through a mobile application, a tablet application, or more generally a computer application, with the ability to directly connect to the Deal Page within or outside the application;
Posting on generally-available web sites (including the Merchant's or Brand's or Group Buying System's) with a link to the Deal Page;
Syndicating through an RSS feed or some other digital syndication mechanism, with a link to the Deal Page;
Direct “peer-to-peer” sharing through Near Field Communication (NFC), infra-red, Bluetooth, WiFi, or some other direct means of communication between individual computers, phones, tablets, or other mobile devices;
Notification to a mobile device or computer device based on the device's physical location with respect to one or more of the Merchant's store locations; and
Publication within an aggregated collection of other deals, offers, or information, such as through a Deal aggregator website or service.

Consumers who become aware of the Deal can then further share the deal with their own contacts, friends, associates, and followers, via any similar means to the ones listed above. At this stage, the Consumer may be able to customize the link to the Deal or the deal message in such a way that the Group Buying System can trace the referral back to the Consumer who shared it, and can reward the sharing Consumer in some way. Alternatively, the Group Buying System may generate links in such a way that it can automatically trace the consumer that shared the link for the purposes of rewarding the consumer or analyzing the path by which deal awareness spreads. Hence, word of the Deal can spread virally through the community of potential Deal buyers.

Once a Consumer has clicked on a Deal link, or has viewed a Deal page, either online, on their mobile or tablet device, through a special-purpose application, or through some other means, the Consumer can choose to Buy the deal. To Buy the deal, the Consumer clicks the Buy button or otherwise indicates their intent to Buy, and then provides the Group Buying System with contact information (such as an email address), payment information (such as a credit card or a PayPal account), and the Consumer's unique identifier at the Merchant (typically this would be a loyalty card number, but could also be a proxy for an account number such as a mobile phone number or email address, or some other unique shopper identifier) for the Merchant at which the Consumer will redeem the Deal. This information may be stored in a user account on the Group Buying Site to eliminate the need to re-enter information when buying subsequent deals, to save user preferences, and to capture additional information about the Consumer. Such additional information could include the user's social network identities (such as their Facebook account), demographic information, marketing/contact preferences, contact information (such as mobile number and postal address), areas of deal interest, and other information. In cases where the Consumer does not have a unique shopper identifier at a Merchant or chain where they desire to Buy a deal, the System may allow for the Consumer to register for a temporary or permanent unique identifier (such as a loyalty card) from within the Group Buying System Registration or Buying process, or it may direct the Consumer to complete a registration process directly with the Merchant, either online, by mobile, by phone, by mail, or in person. The System could also track multiple accounts across multiple merchants, and could use the consumer's purchasing behavior across multiple such accounts to develop a more complete profile of the individual.

During or following the Deal buying process, the Group Buying System collects funds from a payment processor using the Consumer's payment information. At intervals, the Group Buying System transfers the collected funds (less any payment processing fees or other fees) to the Merchant at which the Consumer will redeem the Deal as an advance payment against the anticipated Deal redemptions. Alternatively, the Group Buying System can transfer the funds to the Brand funding the Deal.

Once the Consumer has purchased the Deal, the Group Buying System may send the Consumer a purchase confirmation message, including information on any limitations around the redemption of the Deal. Such limitations may include the requirement that the Consumer wait until the next business day before the Deal will be loaded to their loyalty card, or time limits after which the Deal will no longer be valid or will only be valid at a reduced value. The Group Buying System also updates its centralized database to record the Deal purchase for the purpose of providing accurate counts of remaining Deals available and to enable accurate accounting reporting on Deal status. At this point in the Deal purchase process, the Group Buying System may facilitate the further sharing of the Deal by the Consumer through the use of a personalized referral link and/or announcement that the Consumer purchased the Deal for sharing via email, posting to Facebook, Twitter, or another social network, texting, or some other means.

On a nightly or other regular basis (or following each Deal purchase made), the Group Buying System sends the Merchant or a third party affiliated with the Merchant a list of the Consumers who purchased the Deal. The Group Buying System may include specific deal parameters (such as items included in the deal, dollar values, limits, etc.) in each update sent to the Merchant, or that information can be configured ahead of time in the Merchant's loyalty management or Point of Sale (POS) software.

After receiving the list of Consumers qualifying for the Deal, the Merchant or third party then updates the list in their loyalty management system to enable said system to apply the Deal to purchases made by the appropriate Consumers. Typically, the loyalty software would be configured to give the appropriate Consumers a free unit of the items indicated in the Deal, and would enforce a limit of one redemption per Consumer. Alternative Deal structures can allow for some dollar value worth of free product from a specified set of products, for some discount to be applied to items within some specified set of products, or for some other discount type. Alternatively, the list of consumers may be loaded into a third party system that communicates with the Merchant's Point of Sale software for the purpose of executing discounts upon consumer checkout.

Upon confirmation from the Merchant or third party that the loyalty cards have been updated with the Deal information (or, upon some regular schedule if the Merchant does not provide such confirmation), the Group Buying System can send the Consumer a message indicating that the Deal is now active and available for redemption at the Merchant. Consumers may additionally access their Deal information through specialized applications to browse active Deals, or to bring together multiple Deals into a shopping list, or to otherwise improve the Consumer's ability to see and understand the list of currently live deals they have.

After the Deal is available for in-store redemption, the Consumer shops at the Merchant at which the Deal was activated for that Consumer. The Consumer purchases the products indicated in the deal, along with any other products they wish to buy. Upon check-out, the Consumer scans their loyalty card, provides their mobile number, or otherwise uniquely identifies himself or herself to the Merchant. The Merchant's Point of Sale system then applies the appropriate discounts and/or free items according to the pre-loaded Deal terms in the Merchant's loyalty management system, or by virtue of communication with the third party system. The Point of Sale software or third party software applies its own logic and method for validating the Consumer against the Deal, and for ensuring that the Consumer can only redeem the Deal once. The total value of the pre-purchased Deal is deducted from the Consumer's purchase total, and the Consumer pays the balance owed (if any) on any other items purchased, or on any portion of the purchase price for products associated with the Deal that is not fully covered by the Deal. In cases where the deal value is applied after-the-fact to an account, the consumer will not receive a discount during the transaction, but will instead receive the value of the deal after the Consumer's transaction has been validated against the purchase requirements of the deal.

On a nightly basis, or on some other regular interval, the Merchant sends the Group Buying System a transaction log containing incremental purchase data from the Merchant's Point of Sale systems. This transaction log can contain information about the specific products purchased, the prices and quantities of those products, any discounts taken (including discounts associated with Deals), and the unique identifiers of the shoppers making each purchase (if appropriate). The Group Buying System processes this transaction log and incorporates the purchase history information into its internal purchase history database. From the transaction log (or from some supplemental file provided by the Merchant), the Group Buying System identifies Deal redemptions, and updates its internal database to reflect which shoppers had redeemed the Deal.

The Group Buying System then provides updated charts, reports, dashboards, and analytics to allow a user to track the buying behavior of various Consumer groups, such as those who viewed the Deal but didn't buy, those who bought the Deal but haven't yet redeemed, and those who both bought and redeemed the Deal. Further, the Group Buying System can allow a user to identify trends and changes in buying behavior of the different Consumer groups before, during, and after the Deal. In addition, the underlying information can be used to provide detailed Deal purchase and redemption reports to both Brands and Merchants for the purpose of tracking ongoing and past Deal performance, reconciling the accounting for the Deal, and alerting each party to the need for any reimbursement or off-invoice allowances based on the number of Deals redeemed and the resulting Deal balance owed to the Merchant by the Brand. Alternatively, the reimbursement process between the Brand and the Merchant can be handled externally to the System, such as by treating the deal values as coupons, and managing the clearing and reimbursement process through established coupon clearinghouse procedures.

Load to Card

Group buying in accordance with one or more embodiments utilizes existing load-to-card discount infrastructure that many grocery Merchants' Point-of-Sale loyalty software supports. Once Consumers have purchased a deal through the Group Buying System, the System transmits a file to the Merchant that lists the loyalty card numbers (or other unique identifiers) of each Consumer who purchased the deal, along with the specific details of the items purchased in the deal. The file could be transmitted on a nightly basis, or with more or less frequency depending on the needs of the Merchant and the Group Buying System. An alternative embodiment to a file could be a real-time, near-real-time, or asynchronous API, web service, or other interface call to the Merchant from the Group Buying system for each new consumer that needs to be loaded.

After receiving the Consumer identifiers, the Merchant then loads the deal information into their loyalty system, such that the indicated Consumers will receive the appropriate deal items for free (or at a predetermined discount) when they check out with those items in the basket.

Data Flow

In some embodiments, The System optionally receives a regular feed of shopper transaction data from participating Merchants. This data is loaded into the System for the purpose of analyzing shopper buying patterns. On a regular (e.g., nightly) basis, the System can provide a feed of shopper and offer information to participating Merchants indicating the specific offers that will be loaded to the shopper's loyalty card. Additionally, there can be regular transfers of accounting information to ensure that deal funders, typically Brands, will appropriately reimburse Merchants.

Analytics and Measurability

The System's effectiveness can be determined through true measurability. To understand the true impact of group deals on shopper behavior, marketers may look to answer a number of questions, such as:

How much do redeemers spend above and beyond the Deal?

Are redeemers new customers or existing customers?
If new, do they keep coming back? How soon? How often? How much do they spend?
If existing, how does their spending change before, during and after the Deal?
What is the impact on sales of the promoted items to the Consumers who bought the Deal?
What is the impact on those shoppers' purchasing in the category, the department, and store wide?

The Group Buying System provides interactive, web-accessible shopper analytics to enable marketers to answer questions such as the ones above. These analytics may include various sales charts, reports, and shopper behavioral targeting tools. Simplified reports and dashboards can encourage marketers to check Deal performance frequently both during and after a deal, and to develop shopper insights from the behavioral response of Deal buyers, non-buyers, control-group shoppers, and other shopper groups.

Flow of Dollars and Product

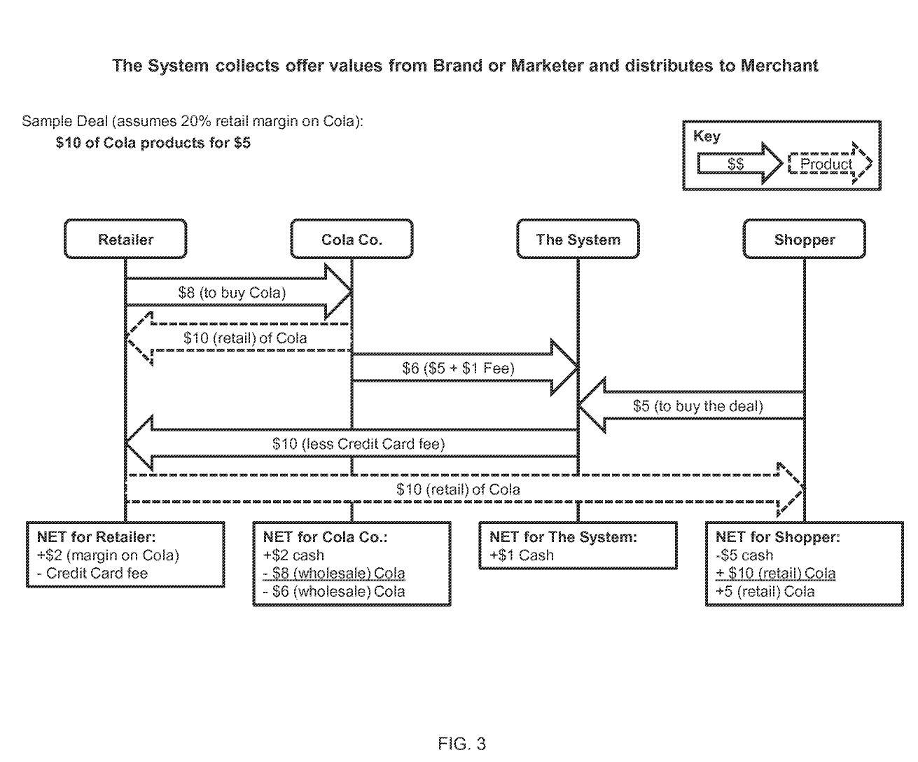

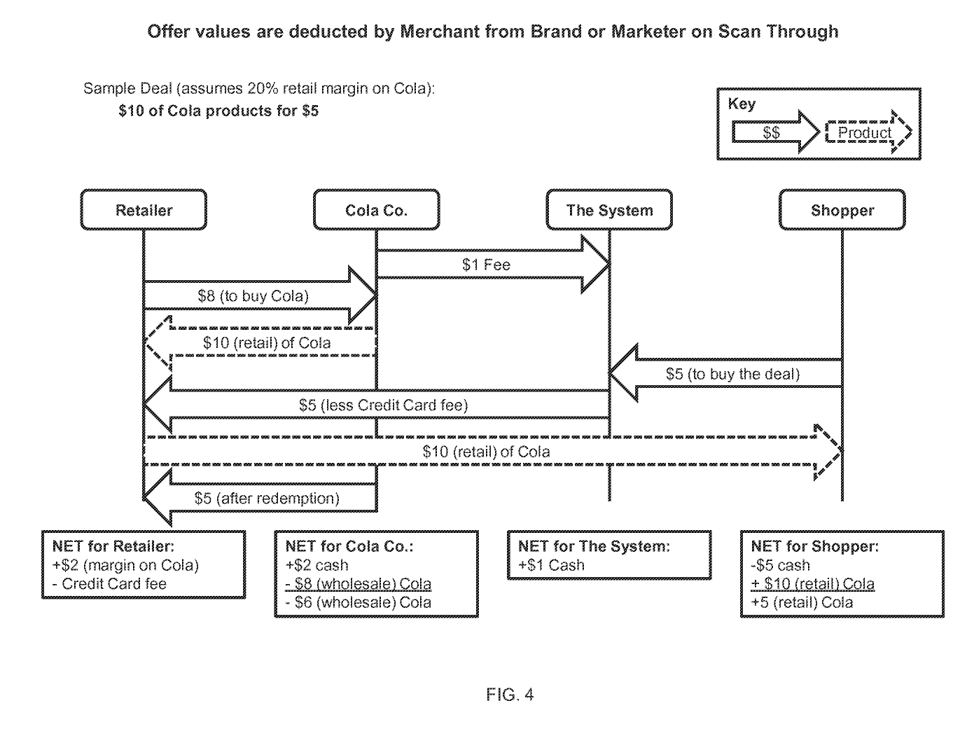

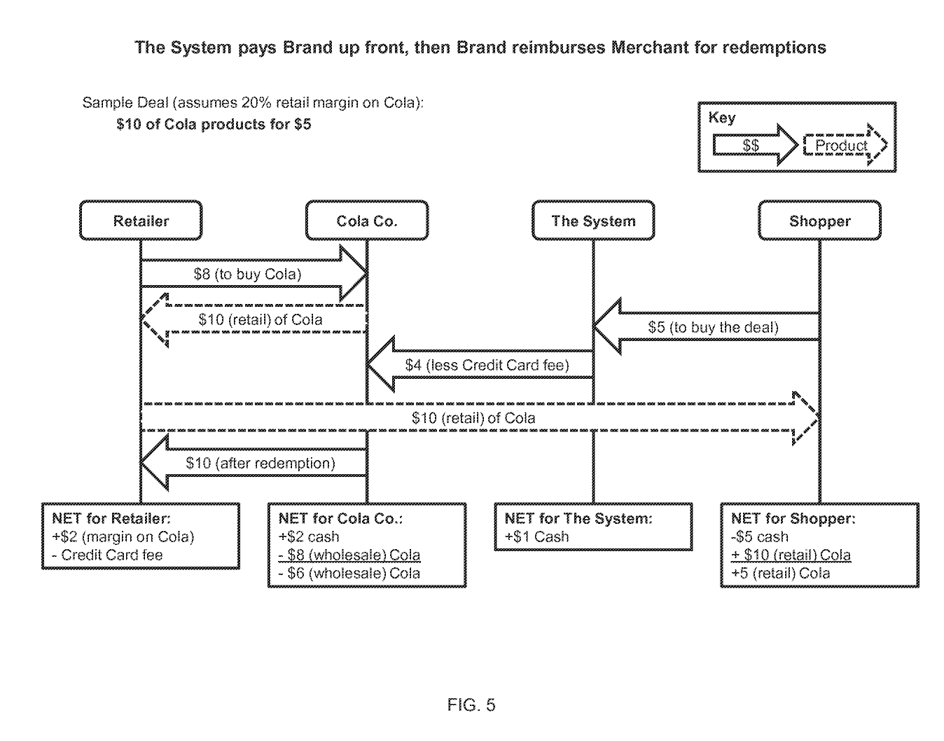

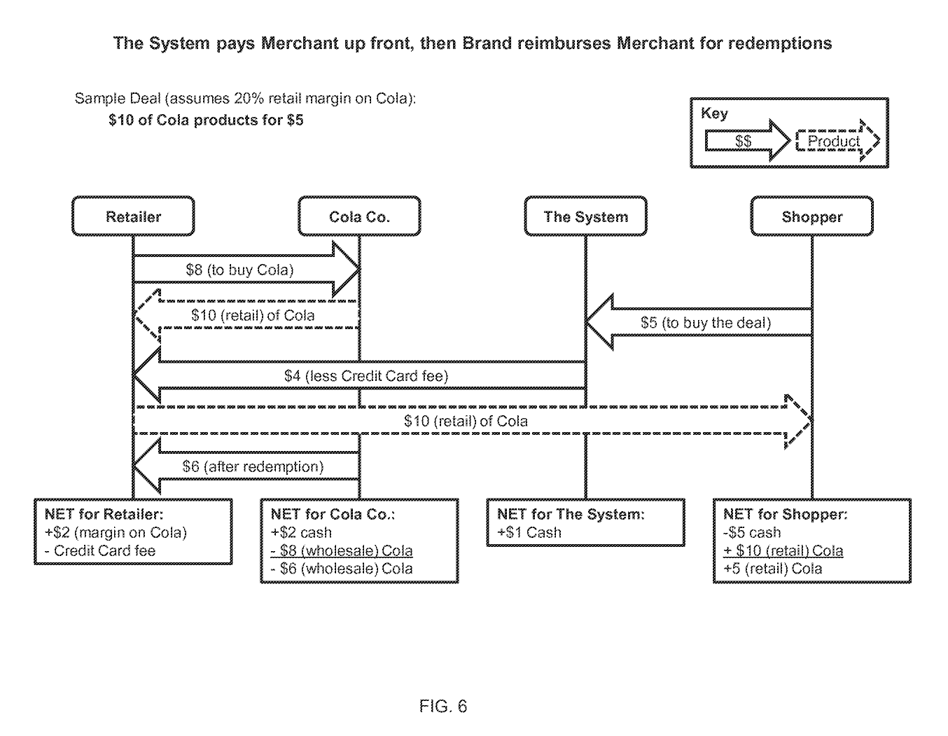

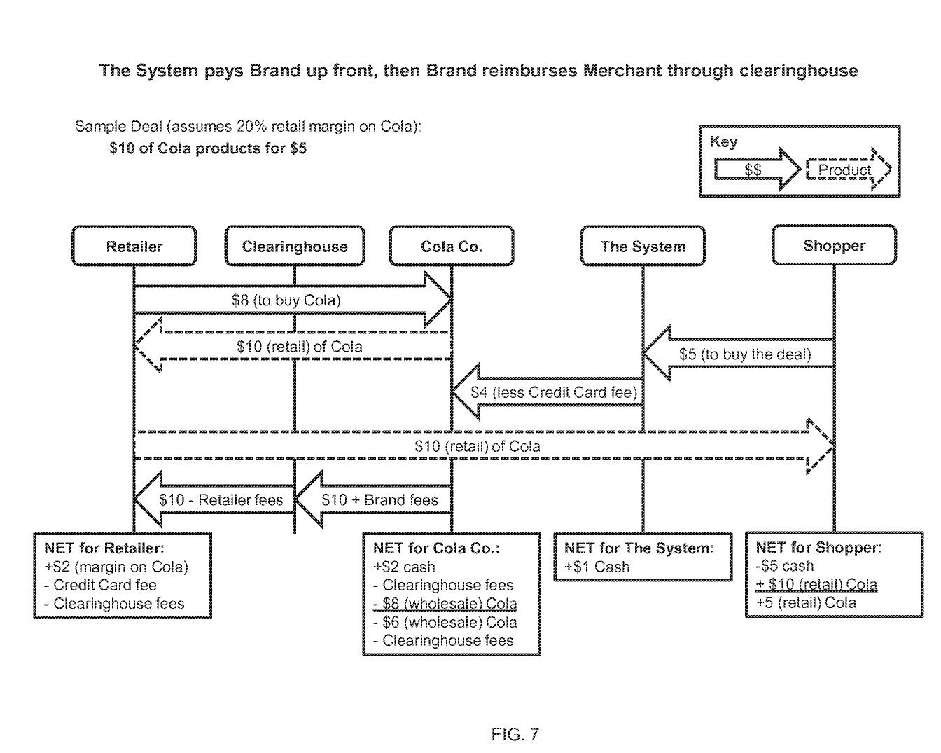

FIGS. 3-7 illustrate different exemplary flows of money between the retailer or Merchant, an example product vendor or Brand (“Cola Co.”), the System, the Consumer or shopper, (and optionally a clearinghouse) in accordance with various embodiments. Note that some of the diagrams do not include such entities as coupon clearinghouses (such as Inmar, NCH, or Prologic), which may act on behalf of the Merchant, the Brand, or both in the handling of the tracking and reconciliation of payment amounts.

Further Alternate Embodiments

Various alternate embodiments are possible, including the following:
Invitation-only Deals could be made available to specific Consumers, based on any number of factors, including the Consumers' past buying behavior at one or more Merchants, the Consumers' Deal purchase patterns, the Consumers' online activity, the Consumers' physical location, or any combination of these or other consumer attributes.
Merchant loyalty identifiers, such as cards, could be used to identify Consumers at Merchants that use a different loyalty system, or who may not have a loyalty system at all. In this way, a consumer might use their grocery loyalty card to identify themselves at a Merchant without a loyalty card (for example, a dry cleaner), and the Merchant could then verify that a consumer purchased a Deal (for example, $40 of dry cleaning for $20) from the Group Buying System through an Interactive Voice Response system, a secure verification website, a mobile application, or some other means. The centralized system would then record that the Consumer redeemed the Deal, and the Deal would be deactivated for that loyalty card.
By accumulating means of identifying a single Consumer across multiple Merchants, a detailed understanding of cross-merchant shopping behavior can be developed.
An identification or loyalty system unique to The System might be developed and separately branded.
A single Deal may be available at multiple Merchants, but the Consumer may still be limited to a single use

The processes of the Group Buying System described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same or similar functions. Accordingly, the foregoing description and drawings are by way of example only, and are not intended to be limiting.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method enabling consumers to purchase products or services from merchants using consumer loyalty programs of the merchants, the method implemented in a computer system communicating with client devices operated by consumers and merchants over a communications network, the method comprising:
(a) using the computer system to transmit a deal to a plurality of client devices operated by consumers, said deal enabling consumers to purchase a given product or service from one of a set of one or more merchants;
(b) receiving at the computer system from a client device operated by a consumer a deal purchase including consumer payment information for the given product or service;
(c) using the computer system to associate the deal purchase received from the consumer with an identifier of a loyalty program account of the consumer in one or more loyalty programs of the set of one or more merchants; and
(d) using the computer system to notify at least one of the set of one or more merchants of the deal purchase such that the consumer can be credited for the deal purchase.

2. The method of claim 1, wherein (d) comprises notifying each of the set of merchants of the deal purchase, and wherein the method further comprises receiving a notification from a merchant that the consumer has redeemed the deal, and making the deal purchase ineligible for future redemptions.

3. The method of claim 1, wherein step (d) comprises receiving a notification from a merchant that the consumer is conducting a transaction involving the product or service in the deal, determining that the consumer has made the deal purchase, and notifying the merchant of the deal purchase.

4. The method of claim 1, wherein the set of one or more merchants comprises a single merchant and the method further comprises notifying the merchant of the deal purchase so that the deal purchase can be loaded on the loyalty account of the consumer and the consumer can be credited for the deal purchase at a point-of-sale checkout.

5. The method of claim 1, further comprising determining that the consumer has purchased the product or service from one of the set of one or more merchants after making the deal purchase, and wherein (d) comprises notifying that merchant of the deal purchase such that the consumer can be subsequently credited for purchasing the product or service.

6. The method of claim 1, further comprising determining that the consumer has purchased the product or service from one of the set of one or more merchants after making the deal purchase, such that the consumer can be subsequently credited for purchasing the product or service by another party.

7. The method of claim 1, further comprising making payment for the product or service to a merchant or to a brand originating the deal.

8. The method of claim 7, further comprising determining a given payment for the product or service to the merchant or the brand originating the deal.

9. The method of claim 1, further comprising: (e) using the computer system to notify the consumer that the deal can be redeemed at one of the set of one or more merchants using a loyalty program account of the consumer.

10. The method of claim 1, wherein the set of one or more merchants comprises one merchant, and wherein the method further comprises: (e) using the computer system to notify the consumer that the deal can be redeemed only at said one merchant.

11. The method of claim 1, further comprising: (e) using the computer system to notify the consumer that the deal can be redeemed at a particular one of the set of one or more merchants using a loyalty program account of the consumer.

12. The method of claim 1, further comprising: (e) using the computer system to notify the consumer that the deal can be redeemed at any one of the set of one or more merchants using a loyalty program account of the consumer.

13. The method of claim 1, wherein the deal enables consumers to purchase the product or service at a discounted price.

14. The method of claim 1, further comprising activating the deal only if at least a given number of deals have been purchased by consumers.

15. The method of claim 1, wherein (c) further comprises creating an identifier for the consumer or receiving an identifier from the consumer for each loyalty program account of the consumer.

16. The method of claim 1, wherein the deal is shareable among consumers through social media.

17. The method of claim 1, wherein the products comprise grocery products.

18. The method of claim 1, further comprising periodically receiving data from a merchant on deal redemptions.

19. The method of claim 18, wherein the data comprises a transaction log containing purchase data from a merchant point-of-sale system.

20. The method of claim 1, further comprising generating analytical data relating to deal purchases and/or redemptions.

21. A computer-implemented method of loading deals purchased by consumers onto their accounts in consumer loyalty programs of merchants, each deal comprising an incentivized purchase of a given product or service from a given merchant, the method comprising:
(a) receiving at the computer system a deal purchase including consumer payment information for the given product or service from a consumer; and
(b) using the computer system to associate the deal purchase with an identifier of an account of the consumer in the consumer loyalty program of the given merchant such that the consumer is credited for the purchase of the product or service.

22. The method of claim 21, further comprising notifying the given merchant of the deal purchase, and receiving a notification from the merchant that the consumer has redeemed the deal, and making the deal purchase ineligible for future redemptions.

23. The method of claim 21, further comprising receiving a notification from the given merchant that the consumer is conducting a transaction involving the product or service in the deal, determining that the consumer has made the deal purchase, and notifying the merchant of the deal purchase.

24. The method of claim 21, further comprising determining that the consumer has purchased the product or service from the merchant after making the deal purchase, and notifying that merchant of the deal purchase such that the consumer can be subsequently credited for purchasing the product or service.

25. The method of claim 21, further comprising determining that the consumer has purchased the product or service from the merchant after making the deal purchase, such that the consumer can be subsequently credited for purchasing the product or service by another party.

26. The method of claim 21, further comprising making payment for the product or service to the merchant or to a brand originating the deal.

27. The method of claim 26, further comprising determining a given payment for the product or service to the merchant or the brand originating the deal.

28. The method of claim 21, further comprising: (e) using the computer system to notify the consumer that the deal can be redeemed at the given merchant using a loyalty program account of the consumer.

29. The method of claim 21, wherein the deal enables consumers to purchase the product or service at a discounted price.

30. The method of claim 21, further comprising activating the deal only if at least a given number of deals have been purchased by consumers.

31. The method of claim 21, further comprising creating an identifier for the consumer or receiving an identifier from the consumer for each loyalty program account of the consumer.

32. The method of claim 21, wherein the deal is shareable among consumers through social media.

33. The method of claim 21, wherein the products comprise grocery products.

34. The method of claim 21, further comprising periodically receiving data from a merchant on deal redemptions.

35. The method of claim 34, wherein the data comprises a transaction log containing purchase data from a merchant point-of-sale system.

36. The method of claim 21, further comprising generating analytical data relating to deal purchases and/or redemptions.
